(19) United States
(12) Patent Application Publication
(10) Pub. No.: US 2003/0225784 A1
(43) Pub. Date: Dec. 4, 2003

(54) Method for managing play lists on a rewritable storage medium

(76) Inventors: Mi Hyun Kim, Seoul (KR); Sung Ryun Cho, Seoul (KR); Byung Jin Kim, Jeongja-dong (KR); Kang Soo Seo, Pyoungan-dong (KR); Sung Wan Park, Suwon-si (KR)

Correspondence Address: BIRCH STEWART KOLASCH & BIRCH, PO BOX 747, FALLS CHURCH, VA, 22040-0747, US

(21) Appl. No.: 10/446,023

(22) Filed: May 28, 2003

(30) Foreign Application Priority Data
May 30, 2002 (KR) 2002-0030422

(51) Int. Cl. G06F 17/00

(52) U.S. Cl. 707/103 R

(57) ABSTRACT

The present method that manages play lists on a rewritable storage medium records additional flag information indicating whether an A/V stream clip is allowed to be partially deleted or edited in a play list corresponding to the A/V stream clip recorded on a rewritable optical disk (BD-RW) and selectively executes a user's request to edit the A/V stream clip depending on the flag information, thereby effectively preventing programs or movies the copyright of which should be protected from being edited illegally.

### BACKGROUND OF THE INVENTION

1. Field of the Invention

The present invention relates to a method for preventing partial deletion or editing of video and/or audio streams recorded on a rewritable storage medium such as an optical disk.

2. Description of the Related Art

Recently, the standardization for new high-density rewritable optical disks capable of recording high-quality video and audio data for a long time is in rapid progress and new optical disk related products are expected to be commercially available on the market in the near future. The Blu-ray Disc Rewritable (BD-RW) is one of the new optical disks.

FIG. 1 illustrates a schematic diagram of a part of an optical disk apparatus such as a video disk recorder (VDR) that records/reproduces data on/from a storage medium like a BD-RW. The optical disk apparatus comprises an optical pickup 2 for reading recorded signals from a storage medium 1 such as a BD-RW or for recording input data on the storage medium 1, a VDR system 3 for processing the signals received from the optical pickup 2 or for converting an input data stream into a data stream formatted for recording, and an encoder 4 for encoding an input analog signal to output the encoded signal to the VDR system 3.

An A/V stream which is continuous in time and stored as a clip file on the BD-RW 1 is managed by a corresponding real play list having playback control information for the A/V stream. In FIG. 2, for example, Clip 1 A/V stream and Clip 2 A/V stream stored on the BD-RW 1 are managed by Real PlayList 1 and Real PlayList 2, respectively.

A virtual play list is created when a user selects some intervals of the recorded clips and makes them referenced by a single play list. As depicted in FIG. 2, a virtual play list, Virtual PlayList 1, may contain both a main-path play item for playing Clip 1 A/V stream referred to by Real PlayList 1 and a sub-path play item for playing Clip 2 A/V stream referred to by Real PlayList 2.

Therefore, if a user's request to play Clip 2 A/V stream is received while Clip 1 A/V stream referenced by Real PlayList 1 is being played, the VDR system 3 of the optical disk apparatus is capable of selectively playing Clip 2 A/V stream referenced by Real PlayList 2.

The VDR system 3 may edit or delete a part of Clip 1 A/V stream or Clip 2 A/V stream according to a user's request. In FIG. 3, for example, Clip 2 A/V stream is partly deleted. In this case, the VDR system 3 stores the streams before and after the deleted interval as Clip 2 A/V stream and Clip 3 A/V stream respectively and creates Real PlayList 2 and Real PlayList 3 containing playback control information for the new clip files.

Also, the VDR system 3 creates a virtual play list for allowing a user to select and edit real play lists. For example, a virtual play list may contain both a main-path play item for playing Clip 1 A/V stream referred to by Real PlayList 1 and a sub-path play item for playing Clip 3 A/V stream referred to by Real PlayList 3.

Therefore, if a user's request to play Clip 3 A/V stream is received while Clip 1 A/V stream referenced by Real PlayList 1 is being played, the VDR system 3 of the optical disk apparatus is capable of selectively playing Clip 3 A/V stream referenced by Real PlayList 3.

Using the aforementioned optical disk apparatus, a user is able to edit or partly delete an A/V stream stored as a clip file. This is quite convenient for the user but it may cause serious copyright infringement because a movie or a program the copyright of which should be protected may be edited illegally.

### SUMMARY OF THE INVENTION

In an effort to solve the foregoing problem, it is the object of the present invention to provide a method that records additional flag information indicating whether an A/V stream clip is allowed to be partially deleted or edited in a play list corresponding to the A/V stream clip recorded on a rewritable optical disk (BD-RW), thereby limiting the function of editing recorded A/V streams depending on the status of the additional flag.

A method for managing play lists on a rewritable storage medium in accordance with one embodiment of the invention comprises the steps of recording a data stream as a clip on a storage medium and recording information indicating whether the recorded data stream clip is allowed to be partially deleted or edited in a play list corresponding to the recorded data stream clip.

A method for managing play lists on a rewritable storage medium in accordance with another embodiment of the invention comprises the steps of receiving a request to partially delete or edit a data stream clip recorded on a storage medium, examining the information indicating whether the data stream clip is allowed to be partially deleted or edited included in a play list corresponding to the data stream clip, and determining whether to execute the received request depending upon the information.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a schematic diagram of a part of an optical disk apparatus such as a video disk recorder;

FIGS. 2 and 3 illustrate A/V streams stored as clip files on a rewritable optical disk (BD-RW), real play lists for the files, and virtual play lists;

FIG. 4 illustrates the file structure of a rewritable optical disk (BD-RW);

FIG. 5 illustrates the syntax of a real play list having the edit protection flag (edit_protect_flag) in accordance with the invention; and

FIG. 6 illustrates a flow diagram of the method for managing play lists on a rewritable storage medium in accordance with one embodiment of the invention.

### DETAILED DESCRIPTION OF THE PREFERRED EMBODIMENTS

In order that the invention may be fully understood, preferred embodiments thereof will now be described with reference to the accompanying drawings.

FIG. 4 illustrates the file structure of a BD-RW. The root directory contains at least one DVR directory, which contains files such as ‘info.dvr’, ‘menu.tidx’, and ‘mark.tidx’ and sub-directories such as PLAYLIST, CLIPINF, and STREAM. The PLAYLIST directory contains play list files (*.rpls and *.vpls). The CLIPINF directory contains clip information files (*.clpi). The STREAM directory contains MPEG2-formatted A/V stream clip files (*.m2ts) corresponding to the clip information files.

The playback control information for the stream files stored in the STREAM directory, for example, ‘01001.m2ts’ and ‘02000.m2ts’, are stored in the files ‘01001.clpi’ and ‘02000.clpi’ contained in the CLIPINF directory, respectively. The play list information for determining continued playback or playback order of the files ‘01001.m2ts’ and ‘02000.m2ts’ are stored in the file ‘01001.rpls’ contained in the PLAYLIST directory.

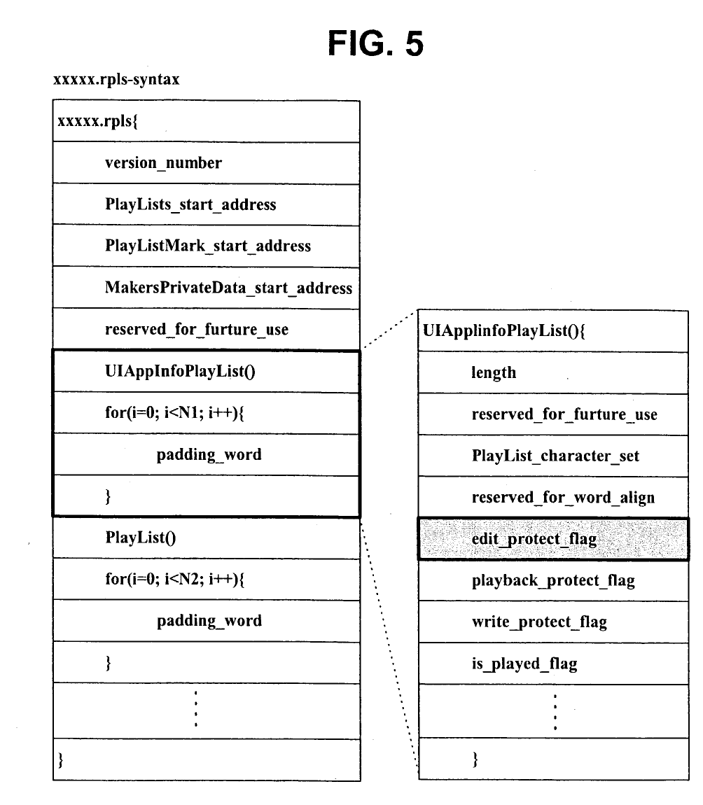

FIG. 5 illustrates the syntax of a real play list, which includes the fields of the version number (version_number), the play list start address (PlayList_start_address), the play list mark start address (PlayListMark_start_address), the maker's private data start address (MakersPrivateData_start_address), and the user interface application information play list (UIAppInfoPlayList). A 1-bit edit protection flag (edit_protect_flag) in accordance with one embodiment of the invention is included in the user interface application information play list.

The edit protection flag (edit_protect_flag) is additionally included in order to prevent a user from partially deleting or editing an A/V stream stored as a clip having time continuity. The edit_protect_flag may be written in 1 bit of the 4-bit fields reserved for word alignment (reserved_for_word_align) or in 1 bit of other reserved bit fields.

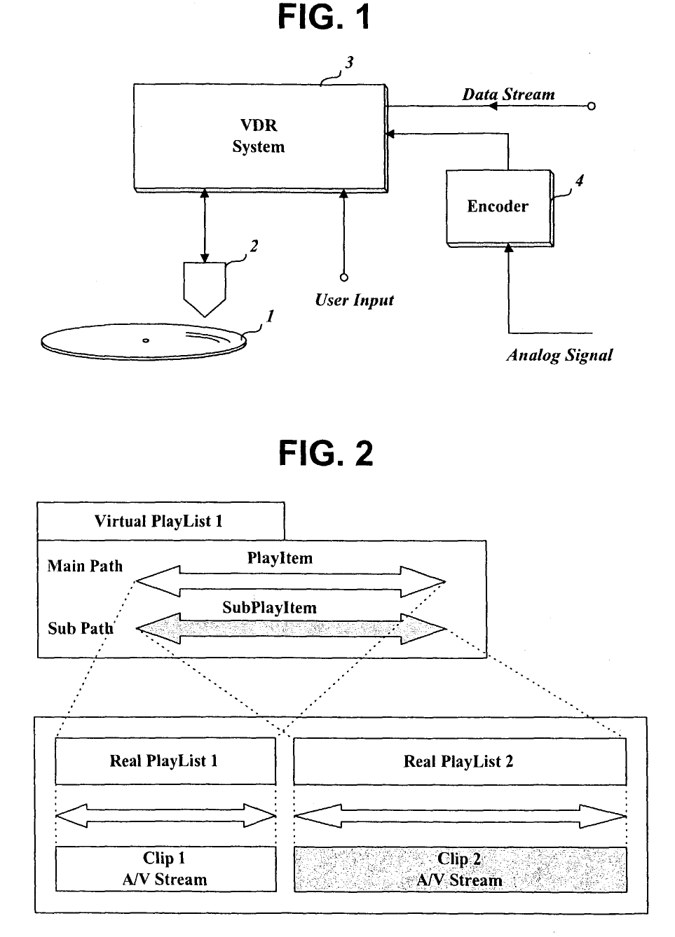

In the case where the edit_protect_flag is set to ‘1’, the VDR system 3 explained above with reference to FIG. 1 executes a procedure for editing prevention so that the corresponding A/V stream may not be deleted or edited by a user, which will be explained below in detail

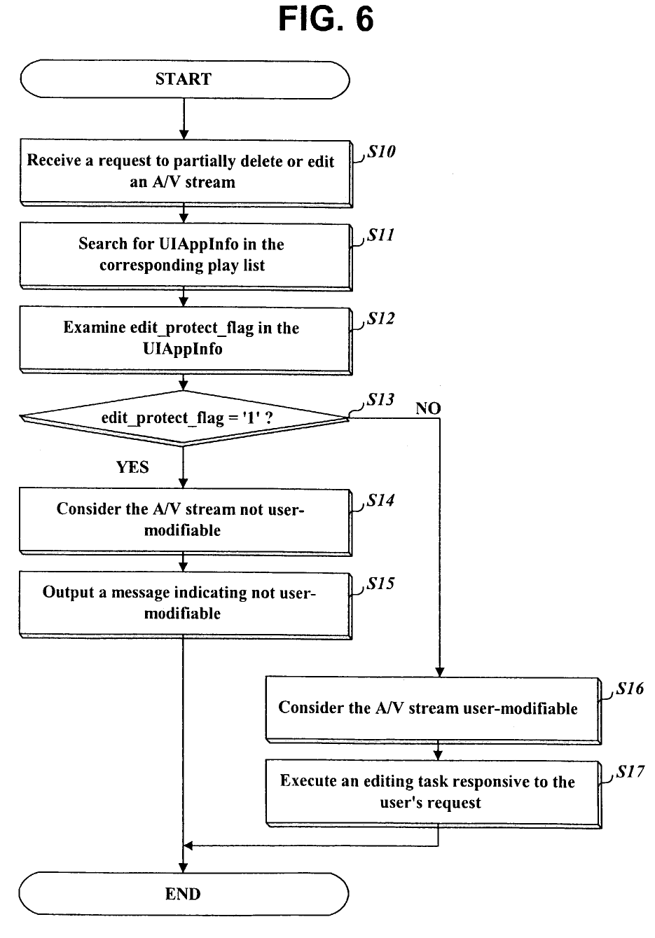

FIG. 6 illustrates a flow diagram of the method for managing play lists on a rewritable storage medium in accordance with one embodiment of the invention. If a request for deleting an A/V stream clip or for including the A/V stream as a play item or a sub-play item in a virtual play list is received from a user (S10), the VDR system 3 searches for the play list corresponding to the A/V stream and searches the user interface application information play list (UIAppInfoPlayList) of the corresponding play list (S11).

The VDR system 3 examines the status of the edit_protect_flag included in the user interface application information play list (UIAppInfoPlayList) of the corresponding play list (S12). If the edit_protect_flag is ‘1’, the VDR system 3 concludes that the copyright of the corresponding A/V stream clip should be protected and hence the corresponding A/V stream clip may not be deleted or edited (S14).

Subsequently, the VDR system 3 generates a message indicating that the clip file is not allowed to be edited and displays the message on an external apparatus through OSD display (S15).

If the edit_protect_flag is ‘0’, the VDR system 3 considers the corresponding clip file user-modifiable and allows the clip file to be modified by a user (S16).

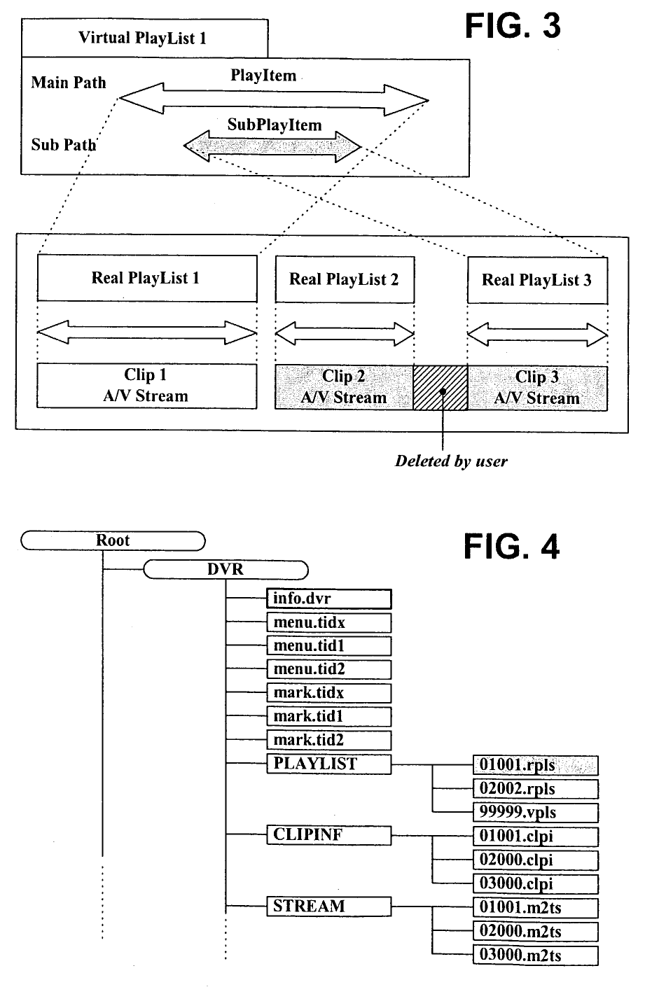

Afterwards, if a request for partially deleting an A/V stream clip or for including the A/V stream as a play item or a sub-play item in a virtual play list is received from a user as explained before with reference to FIG. 3, the VDR system 3 performs necessary editing steps (S17).

The aforementioned edit protection flag may be set automatically by navigation information contained in a received data stream as well as set manually by a user's request.

The method for managing play lists on a rewritable storage medium in accordance with the invention effectively prevents broadcast programs or movies the copyright of which should be protected from being edited illegally.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A method for managing play lists on a rewritable storage medium, comprising the steps of:
recording a data stream as a clip on a storage medium; and
recording information indicating whether the recorded data stream clip is allowed to be partially deleted or edited in a play list corresponding to the recorded data stream clip.

2. The method of claim 1, wherein said information is intended not to allow said data stream clip to be referred to by a virtual play list created by a user's selection of some intervals of data stream clips.

3. The method of claim 1, wherein said information is recorded as an additional flag in the user interface application information play list (UIAppInfoPlayList) of a real play list corresponding to said data stream clip.

4. The method of claim 1, wherein said information is included in the navigation information contained in a data stream received from an external source.

5. The method of claim 4, wherein said information is a 1-bit flag.

6. A method for managing play lists on a rewritable storage medium, comprising the steps of:
receiving a request to partially delete or edit a data stream clip recorded on a storage medium;
examining the information indicating whether the data stream clip is allowed to be partially deleted or edited included in a play list corresponding to the data stream clip; and
determining whether to execute the received request depending upon the information.

7. The method of claim 6, wherein said information is intended not to allow said data stream clip to be referred to by a virtual play list created by a user's selection of some intervals of data stream clips.

8. The method of claim 6, wherein said information is recorded as an additional flag in the user interface application information play list (UIAppInfoPlayList) of a real play list corresponding to said data stream clip.

9. The method of claim 6, wherein said information is a 1-bit flag.

10. The method of claim 9, wherein said determining step further comprises the step of creating and outputting a message indicating that said data stream clip is not allowed to be partially deleted or edited.
